(19) United States
(12) Patent Application Publication
(10) Pub. No.: US 2025/0285603 A1
(43) Pub. Date: Sep. 11, 2025

(54) PIANO WITH DROP ACTION

(71) Applicant: KABUSHIKI KAISHA KAWAI GAKKI SEISAKUSHO, Hamamatsu-shi (JP)

(72) Inventor: Mitsuo YAMASHITA, Hamamatsu-shi (JP)

(21) Appl. No.: 19/068,801

(22) Filed: Mar. 3, 2025

(30) Foreign Application Priority Data
Mar. 7, 2024 (JP) 2024-035159

(51) Int. Cl. G10C 3/18

(52) U.S. Cl. CPC G10C 3/18

(57) ABSTRACT

A piano includes a first key on an upper side rotatably supported at a rear end by a balance pin via a balance pin hole, and pressed by a player, a second key on a lower side rotatably supported at a central portion, the second key a front end of which the first key abuts, an action that is arranged below the second key and includes a whippen that is rotated upward to drive a hammer to perform string striking, a wire material that lifts the whippen in response to press of the first key, and a keystop rail that comes into contact with a pin rear portion of the first key from above and prevents lift of the first key in the vicinity of the balance pin hole to such an extent that the first key does not pry when the first key is pressed.

### BACKGROUND

### Technical Field

The present invention relates to a piano with a drop action, which is an action arranged below a keyboard.

### Related Art

Conventionally, as a piano with a drop action (hereinafter, “drop action piano”), for example, a piano disclosed in Japanese Utility Model Publication No. 49-2178 is known. This piano is provided with a plurality of keys (white keys and black keys) extending in a front-rear direction and rotatably supported by a balance pin in a central portion, and an action arranged behind and below the keys. A configuration of the action is basically the same as a normal action of an upright piano, and when the key is pressed, a whippen is rotated upward by an extension lever coupled to a rear end of the key, and a hammer is rotated rearward to perform string striking by the hammer.

In this conventional drop action piano, since the key is supported in the central portion, an entire length of the key, eventually a depth (length in the front-rear direction) of the piano increases. The applicant has already proposed a drop action piano for solving this problem (for example, Japanese Patent Application No. 2023-057064). As illustrated in FIG. 5, the piano includes a keyboard having upper and lower two stages in which a first key 2A on an upper side is supported at a rear end by a balance pin 6a erected on a keyframe 6 via a balance pin hole 6b. Note that, a reference numeral 6c in FIGS. 5 and 6 represents a concave portion formed on a lower surface of the first key 2A for preventing the first key 2A from interfering with the keyframe 6 during rotation.

As illustrated in FIGS. 7A and 7B, the balance pin hole 6b formed on the first key 2A is formed of a pin receiver 6d on a lower side and a guide 6e continuous on an upper side thereof. The pin receiver 6d is formed of a round hole having a circular horizontal cross section opened on the lower surface of the first key 2A and slightly extends upward, and a diameter thereof is set to such a size that the pin receiver 6d is appropriately engaged with the balance pin 6a in a state in which there is neither backlash nor stick. In contrast, the guide 6e is formed of a square hole having a rectangular horizontal cross section widened symmetrically in the front-rear direction and the right-left direction around the pin receiver 6d, extends upward from the pin receiver 6d, and is opened on an upper surface of the first key 2A. In the vicinity of the opening, a pair of right and left bushing cloths 10 for preventing noise and suppressing wear are adhered from the upper surface of the first key 2A to an upper portion of an inner surface of the guide 6e. With the above-described configuration, the first key 2A is rotatably supported by the balance pin 6a in a state in which the pin receiver 6d of the balance pin hole 6b is engaged with the balance pin 6a.

In contrast, a second key 2B on a lower side is supported in a bearing groove 31d of a support member 31 via a shaft 2d in a central portion, and a rear end of the second key 2B and a whippen 21 of an action 3 are coupled by a wire material 33. Then, by pressing the first key 2A and pressing down a front end of the second key 2B by an actuator pin 8, the whippen 21 is lifted up by the rear end of the second key 2B rotated upward and the wire material 33, and by rotating a hammer 4 rearward, string striking (striking of a string S) by the hammer 4 is performed.

### CITATION LIST

### Patent Literature

Patent Literature 1: Japanese Utility Model Publication No. 49-2178

### SUMMARY

As illustrated in FIG. 6, in a drop action piano including a keyboard of upper and lower two stages described above, the first key 2A on the upper side is supported by the balance pin 6a at the rear end unlike a key of a normal upright piano, and an action functioning also as a weight (reaction force) is not placed on a portion behind the balance pin 6a. Therefore, when the first key 2A is fully pressed, a portion indicated by an arrow Y in FIG. 6 of the first key 2A is lifted from the keyframe 6, so that a wall surface of the pin receiver 6d of the balance pin hole 6b of the first key 2A is likely to be strongly pressed against the balance pin 6a. In this case, smooth rotation of the first key 2A is hindered, for example, the first key 2A returns with delay, and an operation of the second key 2B becomes unstable, which hinders piano performance. Note that, in the present specification, when the wall surface of the pin receiver 6d of the balance pin hole 6b of the first key 2A is strongly pressed against the balance pin 6a as described above, this is referred to as to “pry”.

The present invention has been made to solve such a problem, and an object thereof is to provide a piano with a drop action capable of securing stable and smooth operation of a first key and a second key by preventing lift and pry of the first key in the vicinity of a balance pin hole when the key is pressed in a case where the first key on an upper side and a second key on a lower side are included.

In order to achieve this object, the invention according to claim 1 includes a first key that is rotatably supported at a rear end by a balance pin via a balance pin hole, the first key that is pressed by a player, a second key that is arranged below the first key and rotatably supported at a central portion, the second key a front end of which the first key abuts, an action that is arranged below the second key and includes a whippen that is rotated upward to drive a hammer to perform string striking, a coupling member that is coupled to a rear end of the second key and the whippen, lifts the whippen to rotate upward as the rear end of the second key rotates upward in response to press of the first key, and a keystop rail that comes into contact with a pin rear portion, which is a portion behind the balance pin of the first key, from above and prevents lift of the first key in the vicinity of the balance pin hole to such an extent that the first key does not pry the balance pin when the first key is pressed.

The piano according to the present invention includes the first key pressed by the player, the second key arranged below the first key, the action including the whippen arranged below the second key, and the coupling member coupled to the rear end of the second key and the whippen. The first key is rotatably supported at the rear end by the balance pin via the balance pin hole. At the time of performance, when the first key is pressed, the front end of the second key is pressed with the first key, so that the second key rotates around a central portion. Accordingly, the rear end of the second key rotates upward, and the coupling member lifts the whippen and rotates the whippen upward, so that the hammer is driven to perform string striking with the hammer.

According to the present invention, the keystop rail comes in contact with the pin rear portion, which is the portion behind the balance pin of the first key, from above, and the keystop rail prevents lift of the first key in the vicinity of the balance pin hole to such an extent that the first key does not pry the balance pin when the key is pressed. As a result, it is possible to surely prevent the lift of the first key in the vicinity of the balance pin hole and pry of the first key caused by the lift, and to secure a stable and smooth operation of the first key and the second key.

The invention according to claim 2 is the piano with a drop action according to claim 1, in which the keystop rail is arranged above the pin rear portion of the first key, and includes a block-shaped main body extending in a right-left direction of the piano, and a contact portion provided at a position corresponding to the first key on a lower surface of the main body and is in line contact or point contact with the pin rear portion in a width direction of the first key.

According to this configuration, the keystop rail includes the contact portion provided on the lower surface of the main body, and the contact portion is in line contact or point contact with the pin rear portion of the first key in the width direction. The contact portion is in line contact or point contact in this manner, so that it is possible to avoid an increase in resistance when the first key rotates in a surface contact state of the keystop rail, and it is possible to smoothly press the first key with a light touch. Since the main body of the keystop rail continuously extends in the right-left direction of the piano and the contact portion is provided only at the position corresponding to the first key, the keystop rail can be formed at a low cost with a small number of parts.

The invention according to claim 3 is the piano with a drop action according to claim 2, in which the main body of the keystop rail is formed of a wooden material, and the contact portion is formed of a pin having a circular cross section made of metal and is arranged on the lower surface of the main body in a length direction of the main body to be bonded.

According to this configuration, the main body and the contact portion of the keystop rail are formed separately from each other, and the former is formed of the wooden material, whereas the latter is formed of the pin having the circular cross section made of metal, and is arranged on the lower surface of the main body in the length direction thereof to be bonded. With this configuration, the keystop rail according to claim 2 including the contact portion attached to the lower surface of the main body and in line contact with the first key is implemented. By appropriately selecting the material of the wooden material forming the main body and the metal forming the contact portion, the keystop rail having desired physical properties (weight, hardness, lubricity and the like) can be formed.

The invention according to claim 4 is the piano with a drop action according to claim 2, in which the keystop rail is formed of a molded product of synthetic resin in which the main body and the contact portion are integrally molded.

According to this configuration, the keystop rail in which the main body and the contact portion are integrated can be obtained as the molded product of synthetic resin, and the number of processing steps and a manufacturing cost can be reduced. Since the molded product has high dimensional accuracy, the keystop rail can be formed with high accuracy.

The invention according to claim 5 is the piano with a drop action according to claim 2, in which a cushion in contact with the contact portion of the keystop rail is attached to an upper surface of the pin rear portion of the first key.

According to this configuration, the cushion attached to the upper surface of the pin rear portion of the first key can secure a cushioning property when the keystop rail comes into contact with the pin rear portion of the first key.

The invention according to claim 6 is the piano with a drop action according to any one of claims 1 to 5, in which the first key is formed of a white key and a black key, the balance pin that supports the white key and the balance pin that supports the black key are arranged at positions different from each other in a front-rear direction, and the keystop rail is formed of a white key keystop rail in contact with the pin rear portion of the white key and a black key keystop rail in contact with the pin rear portion of the black key.

According to this configuration, the balance pin that supports the white key and the balance pin that supports the black key of the first key are arranged at different positions in the front-rear direction, and the white key keystop rail in contact with the pin rear portion of the white key and the black key keystop rail in contact with the pin rear portion of the black key are separately configured. With this configuration, a pressing operation of the white key by the white key keystop rail and a pressing operation of the black key by the black key keystop rail can be smoothly performed independent from each other without interference.

### BRIEF DESCRIPTION OF DRAWINGS

FIG. 1 is a side view illustrating a keyboard device, an action, a hammer and the like of a piano to which the present invention is applied in a key release state;

FIG. 2 is a side view illustrating the piano in FIG. 1 in a key pressed state;

FIG. 3A is a plan view illustrating the keyboard device in FIG. 1, and FIG. 3B is a side view thereof;

FIG. 4 is a partially enlarged side view of an arrow A portion in FIG. 1;

FIG. 5 is a side view illustrating a keyboard device, an action, a hammer and the like of a piano proposed by an applicant in a key release state;

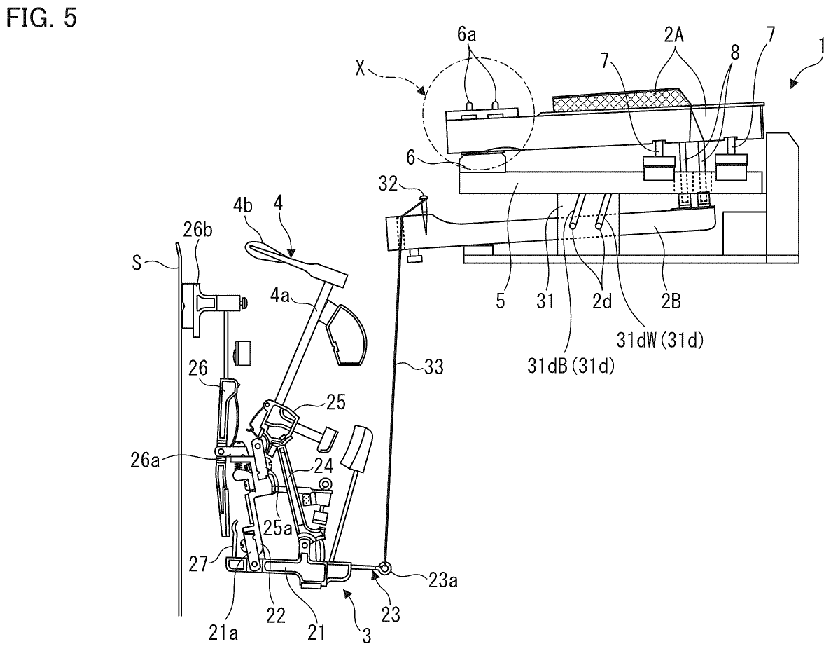

FIG. 6 is a partially enlarged side view of an arrow X portion in FIG. 5; and

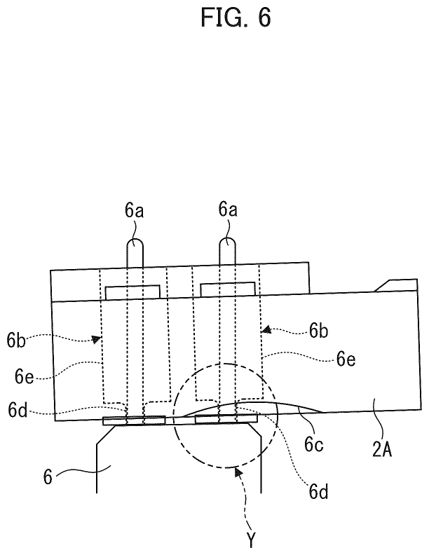

FIG. 7A is a partially enlarged plan view illustrating a configuration in the vicinity of a balance pin hole of a first key, and FIG. 7B is a cross-sectional view taken along line Z-Z′.

### DETAILED DESCRIPTION

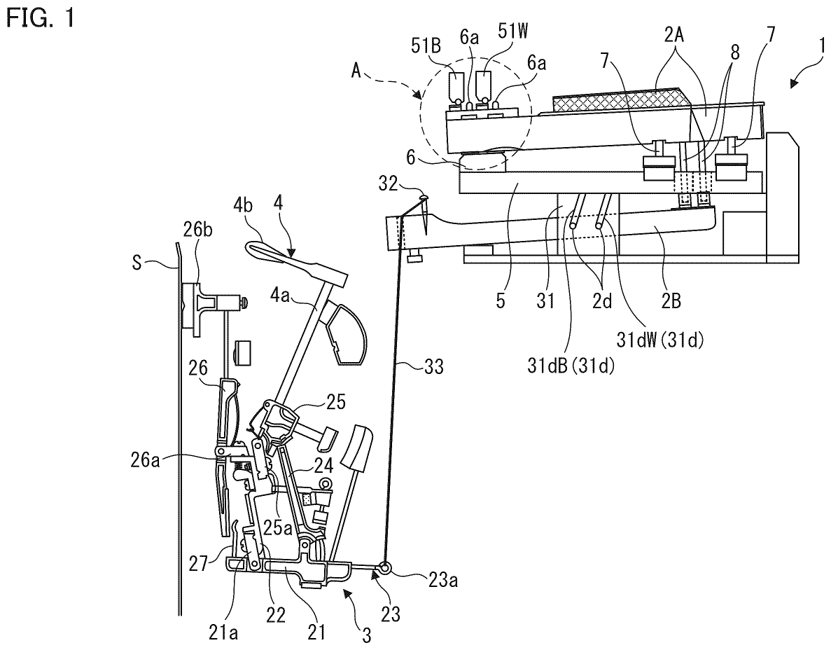

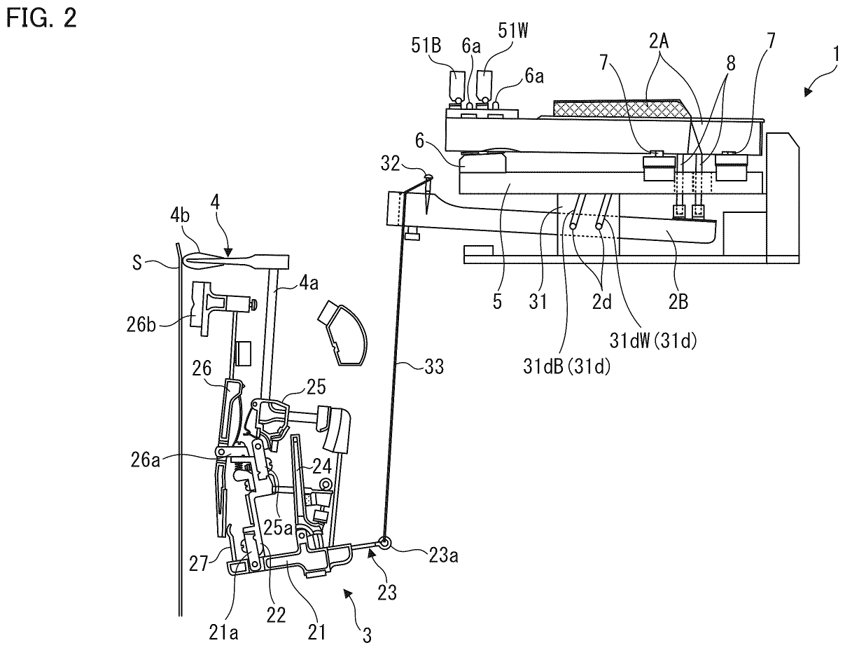

Hereinafter, a preferred embodiment of the present invention will be described in detail with reference to the drawings. As illustrated in FIGS. 1 and 2, a piano 1 to which the present invention is applied is provided with a keyboard 2, an action 3 as a drop action, a hammer 4 and the like. Note that, in the following description, a front side of the piano 1 as seen from a player side is referred to as “front”, a back side is referred to as “rear”, a left side is referred to as “left”, and a right side is referred to as “right”.

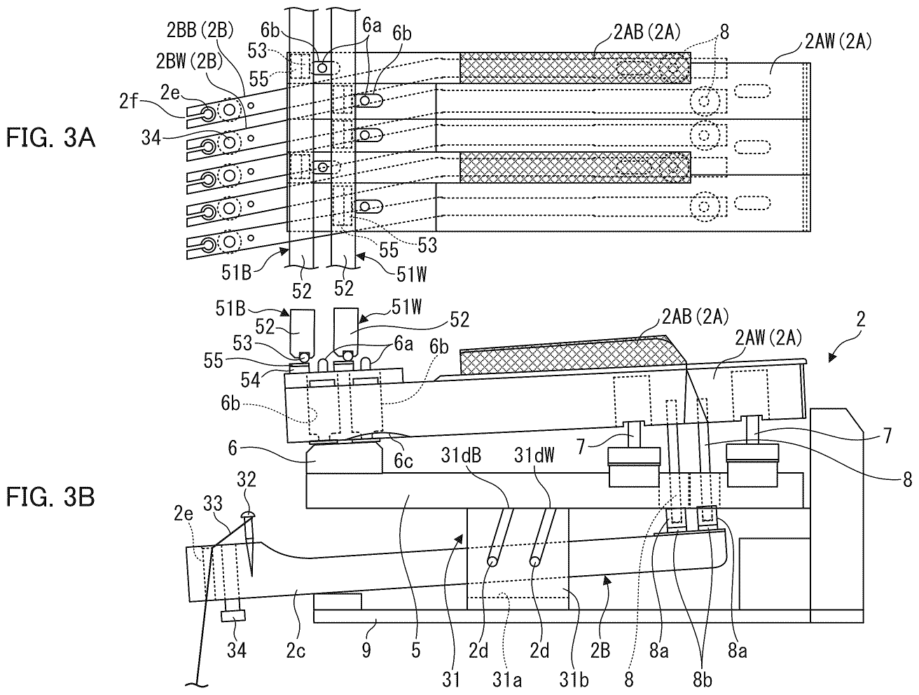

As illustrated in FIGS. 3A and 3B, the keyboard 2 includes a large number of first keys 2A (white keys 2AW and black keys 2AB) arranged in a right-left direction of the piano 1, and a large number of second keys 2B (only one is illustrated) arranged below the first keys 2A, respectively, and arranged in the right-left direction. Each of the first keys 2A extends in a front-rear direction (right-left direction in FIG. 1), is rotatably supported at a rear end thereof by a balance pin 6a erected on a keyframe 6 on a keybed 5 via a balance pin hole 6b, and is guided at a front portion thereof by a front pin 7. A concave portion 6c for preventing the first key 2A from interfering with the keyframe 6 during rotation is formed on a lower surface of the first key 2A in the vicinity of the balance pin 6a.

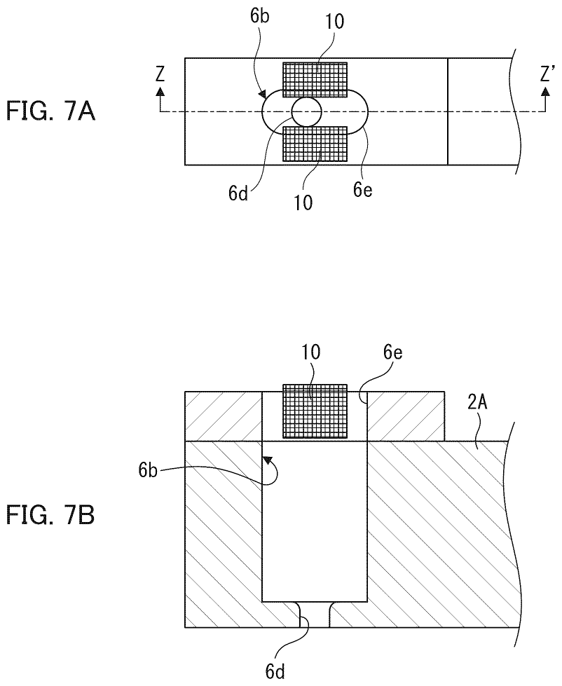

As described above with reference to FIGS. 7A and 7B, the balance pin hole 6b of the first key 2A is formed of a pin receiver 6d on a lower side and a guide 6e on an upper side. The pin receiver 6d is formed of a round hole opened on the lower surface of the first key 2A and slightly extends upward, and a diameter thereof is set to such a size that the pin receiver 6d is appropriately engaged with the balance pin 6a in a state in which there is neither backlash nor stick. The guide 6e is formed of a square hole widened symmetrically in the front-rear direction and the right-left direction around the pin receiver 6d, extends upward from the pin receiver 6d, and is opened on an upper surface of the first key 2A. In the vicinity of the opening, a pair of right and left bushing cloths 10 for preventing noise and suppressing wear are adhered from the upper surface of the first key 2A to an upper portion of an inner surface of the guide 6e. With the above-described configuration, the first key 2A is rotatably supported by the balance pin 6a in a state in which the pin receiver 6d of the balance pin hole 6b is engaged with the balance pin 6a.

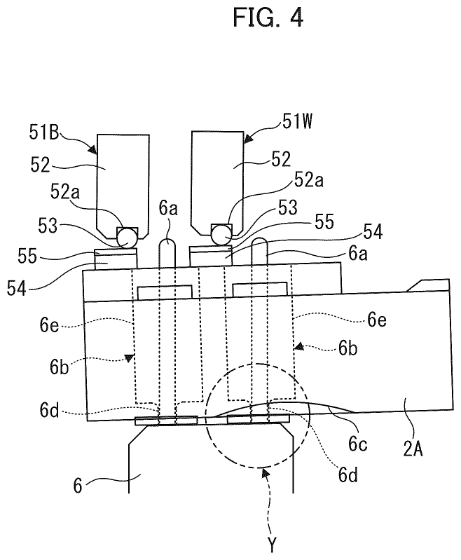

As illustrated in FIGS. 3A, 3B, and 4, the balance pin 6a that supports the white key 2AW is arranged on a front side, and the balance pin 6a that supports the black key 2AB is arranged on a rear side. A white key keystop rail 51W is arranged above a portion (pin rear portion) immediately behind the balance pin 6a of the white key 2AW, and a black key keystop rail 51B is arranged above a portion (pin rear portion) immediately behind the balance pin 6a of the black key 2AB. Hereinafter, the white key keystop rail 51W and the black key keystop rail 51B are collectively referred to as the “keystop rail 51”.

The white key keystop rail 51W is formed of a block-shaped main body 52 and a plurality of pins 53 attached to the main body 52. The main body 52 is formed of a wooden material, has a substantially rectangular cross section elongated in an up-down direction, extends continuously in the right-left direction of the piano 1, and is fixed to a piano main body at both ends thereof. A pin attaching groove 52a is continuously formed on a lower surface of the main body 52. The pin 53 is made of metal such as iron and has a circular cross section, is arranged at a position corresponding to the white key 2AW, and is partially accommodated in and bonded to the pin attaching groove 52a of the main body 52.

In contrast, a cushion 54 and a surface material 55 are sequentially provided on an upper surface of the pin rear portion of each white key 2AW, and the pin 53 of the white key keystop rail 51W is in line contact with the cushion 54 via the surface material 55. The cushion 54 is formed of a synthetic resin and the like having an appropriate cushioning property, and is also used for adjusting its own height. The surface material 55 is a plate-shaped material formed of a synthetic resin having lubricity, and has a function of suppressing friction and noise.

The black key keystop rail 51B is configured in a manner similar to that of the white key keystop rail 51W, and is formed of the block-shaped main body 52 continuously extending in the right-left direction of the piano, and a plurality of pins 53 partially accommodated and bonded at positions corresponding to the black keys 2AB in the pin attaching groove 52a of the main body 52. The cushion 54 and the surface material 55 are sequentially provided on an upper surface of the pin rear portion of each black key 2AB, and the pin 53 of the black key keystop rail 51B is in line contact with the cushion 54 via the surface material 55.

An actuator pin 8 extending downward through the keybed 5 is provided at a front portion of the lower surface of the first key 2A. A cap 8a for adjusting a height is fitted to a lower end of the actuator pin 8. A bushing cloth 8b is adhered to a lower surface of the cap 8a, and the actuator pin 8 abuts a front end of an upper surface of the second key 2B via the bushing cloth 8b.

The second key 2B is arranged between the keybed 5 and a bottom plate 9 below the same, and is rotatably supported by a support member 31. As illustrated in FIGS. 3A and 3B, the second keys 2B include a second key for black key 2BB corresponding to the black key 2AB and a second key for white key 2BW corresponding to the white key 2AW. The second key for black key 2BB and the second key for white key 2BW each include a key main body 2c having the same shape and dimension, and a pair of shafts 2d and 2d provided at different positions in the front-rear direction of the key main body 2c.

The key main body 2c extends in the front-rear direction, and has a planar shape of a slightly bent “\hat{ }” shape and a linear side surface shape having a constant height except for a slightly raised rear end. An adjusting screw 32 is screwed into a rear end of an upper surface of the key main body 2c, and a guide hole 2e penetrating in the up-down direction is formed immediately behind the same, and an upper end of the wire material 33 to be described later is wound around a shaft of the adjusting screw 32 and passes through the guide hole 2e. A slit 2f penetrating in the up-down direction and communicating with the guide hole 2e is formed on a rear end surface of the key main body 2c. A weight 34 is attached between the adjusting screw 32 of the key main body 2c and the guide hole 2e.

The shafts 2d and 2d of the second key 2B are integrally provided on right and left side surfaces of the key main body 2c and protrude to the right and left sides. The shaft 2d of the second key for white key 2BW is arranged at a position about ⅓ of an entire length from a front end of the key main body 2c, and the shaft 2d of the second key for black key 2BB is arranged behind the second key for white key 2BW.

In contrast, the support member 31 is attached to the bottom plate 9. The support member 31 integrally includes a base 31a and a plurality of support walls 31b (only one is illustrated) erected on the base 31a. The plurality of support walls 31b is arranged in the right-left direction at intervals. On each support wall 31b, a white key bearing groove 31dW is formed on a front side, and a black key bearing groove 31dB is formed on a rear side so as to open upward and extend obliquely.

As illustrated in FIGS. 3A and 3B, the second key for white key 2BW is rotatably supported by the support member 31 in a state in which the key main body 2c is accommodated between the corresponding two support walls 31b and 31b, and the shafts 2d and 2d are passed through the white key bearing grooves 31dw and 31dW and engaged with bottom portions thereof. Similarly, the second key for black key 2BB is rotatably supported by the support member 31 in a state in which the key main body 2c is accommodated between the corresponding two support walls 31b and 31b, and the shafts 2d and 2d are passed through the black key bearing grooves 31dB and 31dB and engaged with bottom portions thereof.

The action 3 is arranged behind and below the first key 2A and the second key 2B, and includes a whippen 21 provided for each of the first keys 2A. The whippen 21 is rotatably supported at its rear end by a center rail 22 extended in the right-left direction via a whippen flange 21a. An attaching screw 23 including a ring 23a is screwed into a front end of the whippen 21, and a lower end of the wire material 33 is engaged with and attached to the ring 23a.

The wire material 33 is formed of a material having appropriate flexibility and strength, for example, a material in which high-strength nylon is used as a core material with a surface coated with fiber, carbon and the like, and is stretched between the adjusting screw 32 of the second key 2B and the attaching screw 23 of the whippen 21. A tension degree is adjusted by turning the adjusting screw 32 and changing a winding amount of the wire material 33 around the shaft.

The configuration of the action 3 other than the whippen 21 is basically the same as that of a normal action of an upright piano, and will be briefly described below. The action 3 includes a jack 24, a bat 25, a damper lever 26 and the like, which are provided for each first key 2A. The jack 24 is formed in an L-shape of a base extending forward and a hammer thrust portion extending upward from a rear end of the base, and is rotatably attached to a central portion of the whippen 21 at a corner between them.

The bat 25 is rotatably supported by the center rail 22 via a bat flange 25a, and the hammer thrust portion of the jack 24 abuts the same from a lower side in a key release state of the first key 2A. A hammer shank 4a of the hammer 4 is erected on an upper surface of the bat 25, and a hammer head 4b is provided at an upper end thereof. The hammer head 4b is opposed to a string S stretched behind the same in the key release state of the first key 2A.

The damper lever 26 extends in the up-down direction, is rotatably supported at its center portion by the center rail 22 via a damper flange 26a, and is provided with a damper 26b at an upper end thereof. In the key release state of the first key 2A, the damper 26b presses the string S, and a spoon 27 erected at the rear end of the whippen 21 is opposed to a lower end of the damper lever 26 from the front.

Next, an operation of the piano 1 having the above-described configuration will be described. When the player presses the first key 2A from the key release state illustrated in FIG. 1, the first key 2A rotates downward (clockwise in FIG. 1) around the balance pin 6a at the rear end, and presses down a front end of the second key 2B via the actuator pin 8. As a result, the second key 2B rotates clockwise around the bottom portion of the bearing groove 31d with which the shaft 2d is engaged, similarly to the first key 1A, and the rear end thereof moves upward, thereby lifting the whippen 21 via the wire material 33. Accordingly, the whippen 21 rotates upward, and the jack 24 provided on the whippen 21 thrusts the bat 25, so that the hammer 4 integrated with the bat 25 rotates rearward and strikes the string S (the state in FIG. 2).

With the rotation of the whippen 21, the spoon 27 integrated therewith moves rearward and presses the lower end of the damper lever 26, so that the damper lever 26 rotates clockwise, and the damper 26b is separated from the string S, whereby sound production by vibration of the string S is secured.

According to the present embodiment, the keystop rail 51 is in contact with the pin rear portion, which is a portion behind the balance pin 6a of the first key 2A, from above, and the keystop rail 51 prevents lift of an arrow Y portion (FIG. 4) of the first key 2A to such an extent that the first key 2A does not pry the balance pin 6a when the key is pressed. As a result, it is possible to surely prevent lift of the first key 2A in the vicinity of the balance pin 6a and pry of the first key caused by the lift, and to secure a stable and smooth operation of the first key 2A and the second key 2B.

Furthermore, since the pin 53 provided on a lower surface of the keystop rail 51 is in line contact with the pin rear portion of the first key 2A in a width direction, it is possible to avoid an increase in resistance when the first key rotates in a surface contact state of the keystop rail, and it is possible to smoothly press the first key 2A with a light touch. Since the main body 52 of the keystop rail 51 continuously extends in the right-left direction of the piano 1 and the pin 53 is provided only at the position corresponding to the first key 2A, the keystop rail 51 can be formed at a low cost with a small number of parts.

Since the white key keystop rail 51W in contact with the pin rear portion of the white key 2AW and the black key keystop rail 51B in contact with the pin rear portion of the black key 2AB of the first keys 2A are configured separately from each other, a pressing operation of the white key 2AW by the white key keystop rail 51W and a pressing operation of the black key 2AB by the black key keystop rail 51B can be smoothly performed independent from each other without interference.

Note that, the present invention is not limited to the described embodiment, and can be implemented in various modes. For example, in the embodiment, the keystop rail 51 includes the main body 52 made of the wooden material and the pin 53 made of metal as a contact portion bonded to the main body 52. There is no limitation, and the keystop rail may be formed of a molded product of a synthetic resin (for example, polyacetal) in which the main body and the contact portion are integrally molded, whereby the number of processing steps and a manufacturing cost of the keystop rail can be reduced. Since the molded product has high dimensional accuracy, the keystop rail can be formed with high accuracy.

In the embodiment, the keystop rail 51 is in line contact with the pin rear portion of the second key 2B via the pin 53, but there is no limitation, and they can be in point contact with each other. As a result, as in a case of line contact, it is possible to avoid an increase in resistance when the first key rotates in a surface contact state of the keystop rail, and it is possible to smoothly press the first key with a light touch.

Furthermore, the materials and the like of the components described in the embodiment are merely examples, and it is a matter of course that other appropriate materials and the like may be adopted. In addition, the detailed configuration can be appropriately changed within the scope of the gist of the present invention.

What is claimed is:

1. A piano with a drop action, the piano comprising:
a first key that is rotatably supported at a rear end by a balance pin via a balance pin hole, the first key that is pressed by a player;
a second key that is arranged below the first key and rotatably supported at a central portion, the second key a front end of which the first key abuts;
an action that is arranged below the second key and includes a whippen that is rotated upward to drive a hammer to perform string striking;
a coupling member that is coupled to a rear end of the second key and the whippen, lifts the whippen to rotate upward as the rear end of the second key rotates upward in response to press of the first key; and
a keystop rail that comes into contact with a pin rear portion, which is a portion behind the balance pin of the first key, from above and prevents lift of the first key in the vicinity of the balance pin hole to such an extent that the first key does not pry when the first key is pressed.

2. The piano with a drop action according to claim 1, wherein the keystop rail is arranged above the pin rear portion of the first key, and includes a block-shaped main body continuously extending in a right-left direction of the piano, and a contact portion provided at a position corresponding to the first key on a lower surface of the main body and is in line contact or point contact with the pin rear portion in a width direction of the first key.

3. The piano with a drop action according to claim 2, wherein the main body of the keystop rail is formed of a wooden material, and the contact portion is formed of metal into a pin shape having a circular cross section, and is arranged on the lower surface of the main body in a length direction of the main body to be bonded.

4. The piano with a drop action according to claim 2, wherein the keystop rail is formed of a molded product of synthetic resin in which the main body and the contact portion are integrally molded.

5. The piano with a drop action according to claim 2, wherein a cushion in contact with the contact portion of the keystop rail is attached to an upper surface of the pin rear portion of the first key.

6. The piano with a drop action according to claim 1, wherein the first key is formed of a white key and a black key, the balance pin that supports the white key and the balance pin that supports the black key are arranged at positions different from each other in a front-rear direction, and the keystop rail is formed of a white key keystop rail in contact with the pin rear portion of the white key and a black key keystop rail in contact with the pin rear portion of the black key.
